(19) United States
(12) Patent Application Publication
(10) Pub. No.: US 2015/0032887 A1
(43) Pub. Date: Jan. 29, 2015

(54) Cloud-Based Access Management and Activity Monitoring of Mobile Devices

(71) Applicant: ZeroDesktop, Inc., San Mateo, CA (US)

(72) Inventors: Frank C. Pesek, Emeryville, CA (US); Richard Sah, San Mateo, CA (US); Young G. Song, Palo Alto, CA (US)

(21) Appl. No.: 14/444,813

(22) Filed: Jul. 28, 2014

Related U.S. Application Data
(60) Provisional application No. 61/859,688, filed on Jul. 29, 2013.

(51) Int. Cl. H04L 12/26

(52) U.S. Cl. CPC H04L 43/04; H04L 43/0876
USPC 709/224

(57) ABSTRACT

A control application executed on a target mobile device monitors applications used on the target mobile device and reports the monitored usage to a monitoring device. The control application receives access restrictions from the monitoring device, where each access restriction specifies a condition defined by a first user for causing the target mobile device to take an action restricting use of the target mobile device by a second user. If the control application detects satisfying of the condition specified by an access restriction, the control application enforces the access restriction at the target mobile device by taking the action specified by the access restriction to restrict the user of the target mobile device by the second user.

### CROSS-REFERENCE TO RELATED APPLICATIONS

This application claims the benefit of U.S. Provisional Patent Application No. 61/859,688, filed Jul. 29, 2013, which is incorporated herein by reference in its entirety.

### BACKGROUND

This disclosure relates generally to monitoring applications used on mobile computing devices, and in particular to monitoring application usage at target mobile devices via remote monitoring mobile devices.

Mobile devices using operating systems such as ANDROID are becoming more popular. These devices offer many conveniences and useful applications for performing various operations. However, there is also the risk of addictive behaviors and access to inappropriate or unintended applications by undesired parties. For example, a parent may provide a child with access to a family tablet. The tablet may include applications that contain sensitive data such as financial information or adult content which would be inappropriate for the child to access.

Current mobile device management (MDM) solutions are targeted for enterprise settings in which a centralized server manages and controls different mobile devices by physically changing the application image and storage partition on the mobile device of a single user. Due to scalability limitations, it is not practical to deploy MDM to a large number of consumer mobile devices where each device may have multiple users sharing the same device since each device may have a different set of applications and restriction policies. Further, these devices cannot be decentralized to have target device to monitor and control local activities.

### SUMMARY

Embodiments described herein provide monitoring and control of application usage at a target device via a remote monitoring device. A control application installed on the target device monitors applications used on the target device and detects installation of new applications on the target device. The control application periodically reports the application usage and installations to a monitoring application executing on the monitoring device, which displays a list of applications installed on the target device and amounts of time the applications have been used to a user of the monitoring device.

In one embodiment, the target device receives one or more access restrictions from a server. The access restrictions specify conditions defined by a first user for causing the target device to take actions restricting use of the target device by a second user. The control application monitors usage of the target device by the second user and reports the monitored usage to a monitoring device accessed by the first user. If the control application detects use of the target device satisfying the conditions specified by the access restrictions, the control application performs the actions specified by the access restrictions. In various examples, the control application terminates execution of applications that have been active for longer than a time limit, disallows use of or uninstalls restricted applications, or disallows use of the target device.

In one embodiment, a server stores one or more access restrictions received from the monitoring device. The server sends the one or more access restrictions to the target device, causing the target device to take the action to restrict use of the target device by the second user responsive to detecting satisfying of the condition. The server also receives usage statistics from the target device that describe use of the target device by the second user. The server sends the usage statistics to the monitoring device.

In one embodiment, the monitoring device receives one or more access restrictions input at the monitoring device by a first user. The monitoring device sends the access restrictions to the server. The monitoring device also receives usage statistics from the target device, and displays the usage statistics to the first user.

### BRIEF DESCRIPTION OF THE DRAWINGS

FIG. 1 is a block diagram of a system environment for monitoring application usage at a target device, according to one embodiment.

FIG. 2 is a block diagram of modules within a server monitoring application usage, according to one embodiment.

FIG. 3 is a block diagram of a control application, according to one embodiment.

FIG. 4 is a block diagram of a monitoring application, according to one embodiment.

FIG. 5 is an interaction diagram illustrating a process for monitoring application usage at a target device, according to one embodiment.

FIG. 6 illustrates an example machine able to read instructions from a machine-readable medium and execute them in a processor, according to one embodiment.

### DETAILED DESCRIPTION OF EMBODIMENTS

Embodiments relate to querying a list of programs installed on a target device and storing the list of such programs on a server. Software installed on the target device generates the list of installed programs on the target device and uploads the list to the server. A monitoring device obtains the application list from the server and enables a supervising entity (e.g., a parent) to control a supervised entity's (e.g., a child) access to applications on the target device. The supervising entity can accurately select programs and impose limits/restrictions on the use of these programs based on the list of applications received from the server. The limits/restrictions as defined by the supervising entity are then sent via the server to the target device. The target device may regularly check the list of programs and send the list to the server. The monitoring device regularly downloads the updated list of programs from the server so that newly installed applications may appear in the monitoring device in a timely fashion. The target device may also defeat potential workarounds by supervised entities (e.g., renaming the application or attempting to install new applications) to circumvent the limits/restrictions.

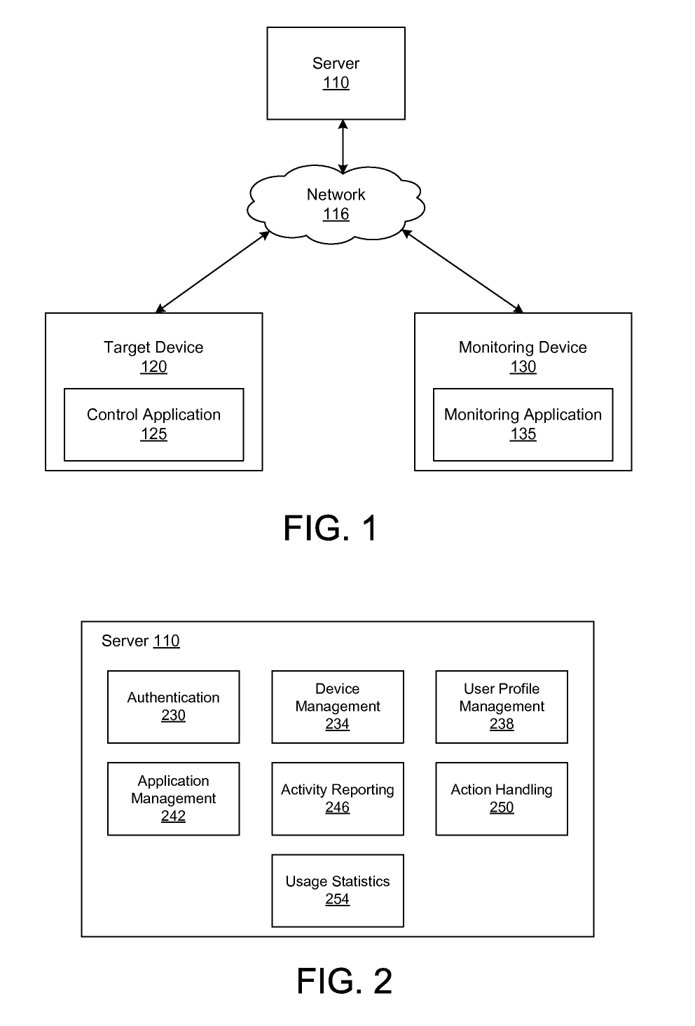

FIG. 1 is a diagram illustrating architecture of a system for monitoring applications on a target device, according to one embodiment. As shown in FIG. 1, one embodiment of the system comprises a server 110, a target device 120, and a monitoring device 130, which communicate through a network 116. While FIG. 1 illustrates a single target device 120 and a single monitoring device 130, other embodiments may include multiple target or monitoring devices. For example, a monitoring device 130 may be used to monitor activities at multiple target devices 120, or a target device 120 may be monitored by multiple monitoring devices 130.

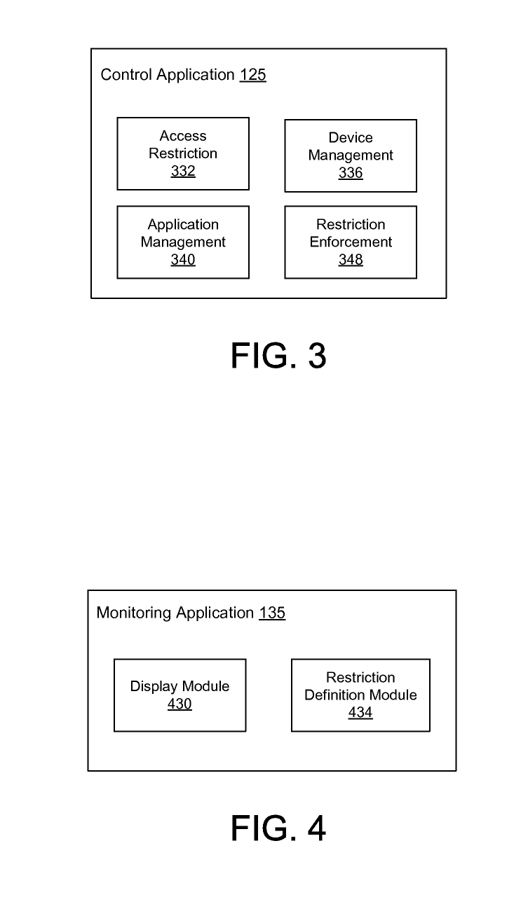

The target device 120 is a device used by a supervised entity. The target device 120 may include any mobile device with communication capability, including but not limited to smartphones, tablet computers, gaming consoles, and personal digital assistants (PDA). The target device 120 is installed with software comprising a control application 125, as described below in detail with reference to FIG. 3. The target device 120 is also installed with software comprising other unrelated applications. The control application 125 may run in the background (i.e., as a daemon) and enables various access control and monitoring operations on the target device 120. One of many advantages of running control application 125 in the background is that there is no visible indication that the application is running. The supervised entity is allowed to enjoy the full features and functionality of the target device 120 unless explicitly blocked by the control application 125. Moreover, the control application 125 may be executed by the target device 120 as a system application, preventing removal of the control application 125 from the target device 120.

The monitoring device 130 is a device used by a supervising entity to monitor the usage of the target device 120 and impose limitations on the use of the target device 120. The monitoring device 130 may be, for example, one or more of a smartphone, a laptop computer, a tablet computer, a desktop computer, a personal digital assistant (PDA), and a handheld computer. The monitoring device 130 is installed with software comprising a monitoring application 135. The monitoring application 135 communicates through the network 116 (e.g., Internet or LAN) to the server 110. The control application 125 installed on the target device 120 communicates through the network 116 to the server 110 to receive access limitations defined by the monitoring application 135 In one embodiment, the monitoring application 135 retrieves real-time usage statistics from the server 110 which had been provided by the control application 125 to facilitate the monitoring of application usage on the target device 120. The monitoring application 135 may also enable the supervising entity to specify access restrictions for the supervised entity's usage of the target device 120. Access restrictions may include time-based restrictions (e.g., restricting an amount of time the supervised entity can use one or more applications on the target device 120) or application-based restrictions (e.g., restricting the supervised entity from using or installing particular applications on the target device 120). The monitoring application 135 sends the access restrictions defined at the monitoring device 130 to the server 110 which are then received by the control application 125, which enforces the access restrictions on the target device 120. The monitoring application 135 may also provide real-time control of the target device 120 independently of the access restrictions by sending requests to the control application 125 (via the server 110) to determine a status of the target device 120, terminate a running application, prevent execution of the application, or entirely block access to the target device 120.

Data between the control application 125 and the monitoring application 135 is communicated via the server 110. The server 110 communicates with the target device 120 and the monitoring device 130 via the network 116. The server 110 authenticates the monitoring device 130, and allows two-way communication between the target device 120 and the monitoring device 130. In one embodiment, the server 110 anonymizes and aggregates application usage statistics from many target devices 120. The server 110 analyzes the aggregated data to determine trends in application usage patterns across a large number of devices.

In an example use case, a user (e.g., the supervising entity) installs the control application 125 on the target device 120 and the monitoring application 135 on the monitoring device 130. When the control application 125 is invoked for a first time on the target device 120, the control application 125 captures a unique identifier of the target device 120. At the monitoring device 130, the monitoring application 135 prompts the supervising entity to enter login credentials (e.g., username and password) to access functionality of the control application 125 on the monitoring device 130. The device identifier captured by the target device 120 and the login credentials captured by the monitoring device 130 are sent to the server 110 for storage. The server 110 then enables communication between the target device 120 and the monitoring device 130 to monitor applications used on the target device 120 and enforce access restrictions at the target device 120.

FIG. 2 is a block diagram illustrating modules within the server 110, according to one embodiment. In one embodiment, the server 110 executes various instruction modules including, but not limited to, an authentication module 230, a device management module 234, a user profile management module 238, an application management module 242, an activity reporting module 246, an action handling module 250, and a usage statistics module 254. Other embodiments of the server 110 may include fewer, additional, or different modules, and one or more of these functionalities may be distributed across differently between the modules.

The authentication module 230 processes registration information for target devices 120 and monitoring devices 130 newly activated with the control application 125 and the monitoring application 135. The registration information may include, among others, the configuration and capabilities of the devices.

The device management module 234 manages information of target devices 120 executing monitoring applications 125 and establishes relational connectivity between the monitoring devices 130 and associated target devices 120. For example, the device management module 234 facilitates the establishment of a link between the monitoring application 135 executed by a monitoring device 130 and the control application 125 executed by a target device 120 during initial setup of the monitoring application 135.

The user profile management module 238 receives access restrictions for each target device 120 executing the control application 125 from the monitoring application 135 of the monitoring device 130. The user profile management module 238 stores the access restrictions to a persistent storage (e.g., hard disk, not shown) for retrieval as needed by the control application 125.

The application management module 242 maintains an inventory list of applications installed on the target device 120. In one embodiment, the application inventory for a target device 120 is updated periodically based on communications received from the control application 125 executing on the target device 120. The application management module 242 provides the inventory to the monitoring device 130 for monitoring application usage and controlling the supervised entity's access to applications.

The activity reporting module 246 receives usage activity reporting data from the target devices 120 and stores the activity reporting to a persistent storage. In response to requests received from the monitoring application 135 of the monitoring device 130, the activity reporting module 246 accumulates and collates relevant usage activity reporting data from the persistent storage. The requested information is transmitted to the monitoring application 135. In one embodiment, the activity reporting module 246 is also configured to determine a status of the target device 120 (e.g., whether the target device 120 is online, or an application is currently active on the target device 120). The activity reporting module 246 sends a status request to the target device 120 by, for example, a push notification, which then triggers the control application 125 of the target device 120 to send a response to the server 110. The activity reporting module 246 sends the response to the monitoring device 130, where the status of the target device 120 may be displayed to the supervising user. In one embodiment, if the activity reporting module 246 does not receive a response to the status request from the target device 120 within a specified period of time (e.g., 30 seconds), the activity reporting module 246 determines the target device 120 is offline.

The action handling module 250 sends access restrictions to the target device 120 for enforcement by the control application 125. In one embodiment, the action handling module 250 retrieves the access restrictions stored by the user profile management module 238. The action handling module 250 may periodically send the access restrictions to the target device 120 to update the access restrictions stored by the control application 125.

The usage statistics module 254 aggregates application usage statistics from multiple target devices 120 executing the control application 125. In one embodiment, the usage statistics module 254 removes personal identification information from the usage data reported to the server 110 (e.g., the unique device identifier of the target device 120) to anonymize the application usage data. Using the anonymized usage data, the usage statistics module 254 determines which applications are being used at target devices 120, how long the applications have been installed on the devices, amounts of time users spend using the applications, or other information regarding the usage of applications at the target devices 120. The usage statistics module 254 may analyze the usage data according to a variety of different factors, including by geographic locations of the target devices 120, the manufacturers of the target devices 120, the operating system executed by the target devices 120, or other factors.

FIG. 3 is a block diagram illustrating components of the control application 125, according to one embodiment. The control application 125 may be executed by the target device 120 as a system application, enabling the control application 125 to control activity related to other applications on the target device 120 and limiting the ability of the user of the target device 120 to terminate the control application 125 or modify the control application 125. In one embodiment, as shown in FIG. 3, the control application 125 comprises an access restriction module 332, a device management module 336, an application management module 340, and a restriction enforcement module 344. Other embodiments of the control application 125 may include fewer, additional, or different modules, and these functionalities may be distributed differently between the modules.

The access restriction module 332 manages time and application access restrictions as defined by the control application and provided by the server 110. The restriction criteria associated with the access restrictions may be cached in a persistent storage (e.g., flash memory or hard disk) to facilitate offline operations. The access restriction module 332 also obtains periodic refreshes of the access restrictions from the monitoring device 130 or the server 110.

The device management module 336 manages unique device identification and characteristics of the target device 120. The device management module 336 retrieves a globally unique identifier of the target device 120 when the control application 125 is installed on the target device 120, and provides the unique identifier to the monitoring device 130 or the server 110. In one embodiment, the device management module 336 also facilitates connectivity to the control application of the monitoring device 130 by managing a descriptive name applied to the target device 120 and personalized access credentials of a user of the control application.

The application management module 340 provides the server 110 with a list of applications installed on the target device 120. In one embodiment, the application management module 340 periodically queries the operating system of the target device 120 through system-level application programming interface (API) calls to retrieve the list of installed applications on the target device 120. The list provided by the operating system provides technical details of each installed application, such as the “friendly” name of the application (e.g., Angry Birds by ROXIO), the version number of the application (e.g., version 2.4.1), the installation date of the application, and the internal program name (e.g., com.rovio.angrybirds) used for launching the specific application on the target device 120. The “friendly” name is a name of the application easily recognizable by human users. Including the internal program name in the list enables the server 110 and monitoring device 130 to accurately monitor usage of an application in spite of attempts by the supervised entity to copy, rename, or otherwise tamper with an installed application with the intent of circumventing access restrictions. Furthermore, use of the internal program name facilitates aggregation of data from many target devices 120 for the purposes of big data reporting such as trends and geographic based activity.

The application management module 340 may also comprise an event listener configured to receive operating system calls upon installation of new applications on the target device 120. The application management module 340 notifies the server 110 and/or the monitoring device 130 when a new application is installed.

The application management module 340 monitors usage of the applications on the target device 120, including launch, termination, and an amount of time the applications are used. The application management module 340 also monitors usage of the target device 120 when no specific application has been invoked. That is, the application management module 340 monitors idle usage of the target device 120 when the target device 120 is powered on but is not actively executing an application. In one embodiment, the application management module 340 gathers usage statistics data based on the status of a running application. For example, if the application is in the “foreground” status, the application is considered to be active and the usage statistics module 344 accumulates usage data of the application. If an application is in the “background” status, the application is not considered active and the usage data is not accumulated. The application management module 340 stores the usage data to a persistent storage on the target device 120 (e.g., hard disk), and periodically provides usage statistics data to the server 110. In one embodiment, the usage data provided to the server 110 by the application management module 340 includes identifiers of applications used on the target device 120 as well as start times and end times of the application usage. In one embodiment the application management module 340 records the time that the target device 120 is switched on but without a currently running application. The data provided to the server 110 may further include an identifier of the target device 120, such as the geographic location, unique device identifier, a manufacturer, a model, or an operating system version of the target device 120. The application management module 340 may compress the usage data sent to the server 110 to reduce latency and bandwidth used to transmit the data. The application management module 340 may report the usage statistics data to the server 110 at specified time intervals (e.g., every 20 minutes), or after a specified number of activities (e.g., 100 events) are detected at the target device 120, or in response to the receipt of a push notification request initiated by the server 110.

In one embodiment, the application management module 340 removes the usage data from the persistent storage on the target device 120 after reporting the data to the server 110 and receiving a confirmation of receipt from the server 110. However, if the target device 120 is offline or otherwise unable to communicate with the server 110 at a time the application management module 340 is scheduled to report usage statistics to the server 110, the application management module 340 continues to collect data for transmittal to the server 110 when the communication between the target device 120 and server 110 becomes available. By continually collecting data even while the target device 120 is offline, the application management module 340 beneficially provides accurate usage statistics to the server 110 and the monitoring device 130. For example, the user of the target device 120 cannot hide use of an application by using the application while the target device 120 is offline (i.e., disconnected from the network 116).

In one embodiment, the application management module 340 is further configured to provide the server 110 with the current status of the target device 120 in response to receiving a status request from the server 110. For example, when the control application 125 receives a status request from the server 110, the application management module 340 determines whether an application is currently active on the target device 120. If an application is currently active, the application management module 340 identifies the active application and returns an identifier of the active application to the server 110.

The restriction enforcement module 344 receives access restrictions from the server 110 and stores the access restrictions on the target device 120. For example, the restriction enforcement module 344 caches the access restrictions on the target device 120 for offline access. The restriction enforcement module 344 may periodically communicate with the server 110 to retrieve updated access restrictions.

The restriction enforcement module 344 enforces the access restrictions on the target device 120. For example, the restriction enforcement module 344 blocks the launch of applications that have been specifically restricted by the supervising entity, terminates applications when time access criteria have been reached, minimizes or hides non-active windows, or implements ad hoc requests from the monitoring device 130 to terminate access to a specified application on the target device 120. In one embodiment, the restriction enforcement module 344 distinguishes between applications executing in the foreground or background, and enforces time limit restrictions or performance usage tracking based on the distinction.

To enforce restrictions at the target device 120, the restriction enforcement module 344 compares the access restrictions to an invoked action at the target device 120 (e.g., launching an application) or an ongoing activity at the target device 120 (e.g., a continued usage of an application). For an access restriction specifying an application that cannot be accessed by the supervised entity, the enforcement restriction module 344 detects a launch attempt for the restricted application and blocks the attempted launch. For an access restriction specifying a time limit for usage of an application at the target device 120, the restriction enforcement module 344 monitors an amount of time the application is used to detect usage of the application exceeding the time limit. If the time limit is exceeded, the restriction enforcement module 344 takes an action such as warning the supervised entity about the time restriction, notifying the supervising entity about the time restriction being exceeded, or terminating the application. For an access restriction restricting the general usage of the target device 120, the restriction enforcement module 344 blocks further activity on the target device 120 until the restriction has been lifted. The restriction enforcement module 344 may also receive commands from the monitoring device 130 via the server 110 to terminate a currently-running application, uninstall an application, or other actions. In response to receive the commands, the restriction enforcement module 344 executes the action specified by the command.

FIG. 4 is a block diagram of the monitoring application 135, according to one embodiment. When the monitoring application 135 is first installed on the monitoring device 130, the supervising entity logs in with user credentials registered with the control application 125 installed on the target device 120. In one embodiment, the user credentials are sent to the server 110 for authentication. If the user credentials are authenticated, a logical relationship between the monitoring application 135 and the control application 125 is established on the server 110 which facilitates communication between the monitoring application 135 and the control application 125 via the server 110.

As shown in FIG. 4, one embodiment of the monitoring application 135 comprises a display module 430 and a restriction definition module 434. Other embodiments of the monitoring application 135 may have different or additional modules, and the functionality may be distributed differently between the modules.

The display module 430 displays application usage data collected at the target device 120 to the supervising entity. The display module 430 displays a list of applications installed on the target device 120 and the status of the target device 120 (e.g., whether the device is online or offline). If the target device 120 is offline, the display module 430 may display the last known application executed on the target device 120. If the target device 120 is online, the display module 430 may display an identifier of the currently-executing application. In one embodiment, the display module 430 provides an interface element to request a current status of the target device 120. For example, the supervising entity initiates an action via the interface element to determine the current status of the target device 120. In response, the display module 430 sends a status request to the server 110. The server 110 issues a push request to the specified target device 120. The target device 120, upon receipt of the push notification, determines the current status and responds to the server 110 with this information. The server 110 then returns the status to the monitoring application 135. The display module 430 displays the status to the supervising entity.

The restriction definition module 434 enables a supervising entity to define access restrictions for the target device 120. In one embodiment, the restriction definition module 434 provides an interface for the supervising entity to set time limits or application restrictions for particular applications installed on the target device 120 or time limits on the general usage of the target device 120. For example, the restriction definition module 434 displays a list of applications installed on the target device 120 (identified, for example, externally by their friendly names and internally by their internal program names). The restriction definition module 434 also displays options for the supervising entity to define time limits for usage of the application or specify applications that may not be used on the target device 120. The restriction definition module 434 uses the inputs received at the user interface to generate the access restrictions, where each access restriction includes an identifier of one or more applications and a limit on usage of the one or more applications. In one embodiment, the identifiers of the applications specified by the access restrictions are the internal program name of the applications. The restriction definition module 434 sends the generated access restrictions to the server 110 for persistent storage of the restriction definitions and also to provide the criteria for enforcement of these restrictions at the target device 120. The restriction definition module 434 may also enable the supervising entity to input ad hoc commands, such as commands to terminate a currently running application at the target device 120 or uninstall an application from the target device 120.

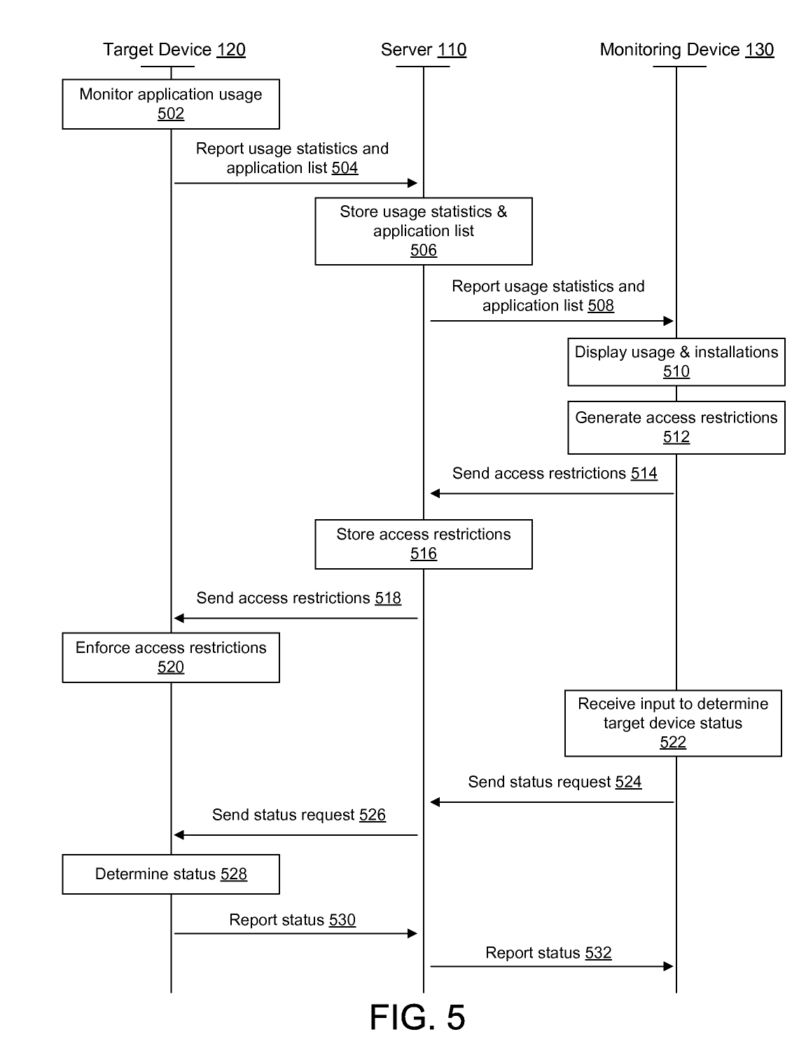

FIG. 5 is a diagram illustrating a process for monitoring application usage at a target device 120 and enforcing access restrictions at the target device 120, according to one embodiment. As shown in FIG. 5, the process includes interactions between the target device 120, the server 110, and the monitoring device 130. In the diagram, time flows from top to bottom and horizontal arrows indicate communications between the entities. Other embodiments may perform the steps of the process in different orders.

The target device 120 monitors 502 usage of applications on the target device 120, including installation of applications, launch of applications, and amounts of time each application is executed in the foreground, as well as general idle time (i.e., device is on but no current application is running) usage of the target device 120. Based on the monitored usage, the target device 120 generates usage statistics describing amounts of time each application on the target device 120 is used or time the target device is on but with no current application running. The target device 120 reports 504 the usage statistics and a list of applications installed on the target device 110 to the server. In one embodiment, the target device 120 reports 504 the usage statistics to the server 110 on a periodic basis (e.g., every 15 minutes, or every 100 events) while the target device 120 is online, and reports 504 identifiers of newly-installed applications to the server 110 when an application is installed. The target device 120 may remove the usage statistics from local storage after successfully reporting 504 the data to the server 110.

The server 110 stores 506 the usage statistics and application list, and reports 508 the usage statistics and application list to the monitoring device 130. In one embodiment, the server 110 anonymizes the usage statistics and aggregates the anonymous statistics with usage statistics received from a plurality of other users. The server 110 may analyze the aggregated statistics to determine which applications are being used at target devices 120, how long the applications have been installed on the devices, amounts of time users spend using the applications, or other information regarding the usage of applications or general idle time at the target devices 120.

The monitoring device 130 displays 510 information about applications installed on the target device 120 and usage of the target device 120 and applications to the supervising entity. For example, the monitoring device 130 displays a list of applications installed on the target device 120, the last known application executed on the target device 120 or the currently-executing application, the amount of time the target device 120 has been switched on and an amount of time applications have been active on the target device 120. In one embodiment, the monitoring device 130 also notifies the supervising entity upon installation of a new application at the target device 120.

The monitoring device 130 generates 512 access restrictions for the target device 120 in response to inputs by the supervising entity at the monitoring device 130. In one embodiment, the monitoring device 130 displays a user interface to the supervising entity for defining access restrictions. The user interface may include friendly names of applications installed on the target device 120 as well as options to specify time limits for use of the applications or to block usage of particular applications. The monitoring device 130 uses inputs received via the user interface to generate access restrictions. In one embodiment, the access restrictions generated by the monitoring device 130 each includes the internal program name of at least one application, a rule for usage of the application, and an action to be performed at the target device if the rule is violated. Other access restrictions generated by the monitoring device 130 comprise commands to limit access to the target device 120 independent of the one or more access restrictions, such as commands to terminate a running application or to uninstall an installed application. The monitoring device 130 sends 514 the access restrictions to the server 110. The server 110 stores 516 the access restrictions, and sends 518 the access restrictions to the target device 120.

The target device 120 enforces 520 the access restrictions by executing the actions specified by the access restrictions. For example, the target device 120 terminates applications that have been active for longer than a time limit defined by the access restrictions or prevents execution of restricted applications.

In one embodiment, communication between the monitoring device 130, the server 110, and the target device 120 also provides the supervising entity with information about a current status of the target device 120. As shown in FIG. 5, the monitoring device 130 receives 522 a user input to request the status of the target device 120. The monitoring device 130 sends 524 the request to the server 110, which in turn sends 526 the request to the target device 120. In one embodiment, the server 110 sends 526 the status request to the target device 120 as a push notification. If the target device 120 is online and receives the status request from the server 110, the target device 120 determines 528 the status in response to receiving the request. For example, the target device 120 determines whether an application is currently active on the target device 120, identifies the active application, or determines whether the target device 120 is in a power-saving mode. The target device reports 530 the status to the server 110, which in turn reports 532 the status to the monitoring device 130 where it may be displayed to a user. In one embodiment, if the target device 120 does not respond to a status request within a specified period of time, the server 110 determines the target device 120 is offline and reports an offline status to the monitoring device 130. In one embodiment, the target device 120 method of reporting the device's status to the server 110 is passive. The target device 120 will only report the device's status to the server 110 upon receipt of a push notification on an as-needed basis, thereby conserving power and bandwidth usage at the target device 120 and reducing storage needed and system resource requirements at the server 110.

As described herein, embodiments enable supervising entities (e.g., parents) to provide access of a mobile device to the supervised entities (e.g., children) while retaining a level of control and activity monitoring on the mobile device. This is particularly useful for parents with young children. The parent can provide the device to the child and, even when the parent is not physically present, continue to monitor and enforce access restrictions through the control application. Access to inappropriate applications and websites can be controlled can be tracked in real-time and countermeasures against such inappropriate access can be also taken in real-time. Furthermore, addictive behavior that is often associated with these kinds of devices can be moderated through usage time restrictions provided by the application.

Moreover, based on the application usage reports received from many target devices 120, embodiments of the server 110 are configured to determine trends in usage of applications. As the target devices 120 persistently execute the monitoring application in the background and the monitoring application tracks any usage of applications while it is executing, the monitoring application obtains accurate statistics related to application usage at the target devices 120, including which applications are used, how often the applications are used, and how long users spend using the applications, without the users changing their behavior due to being monitored. The usage statistics aggregated by the server 110 provide valuable information to application developers, device manufacturers, parents, school administrators or teachers and others.

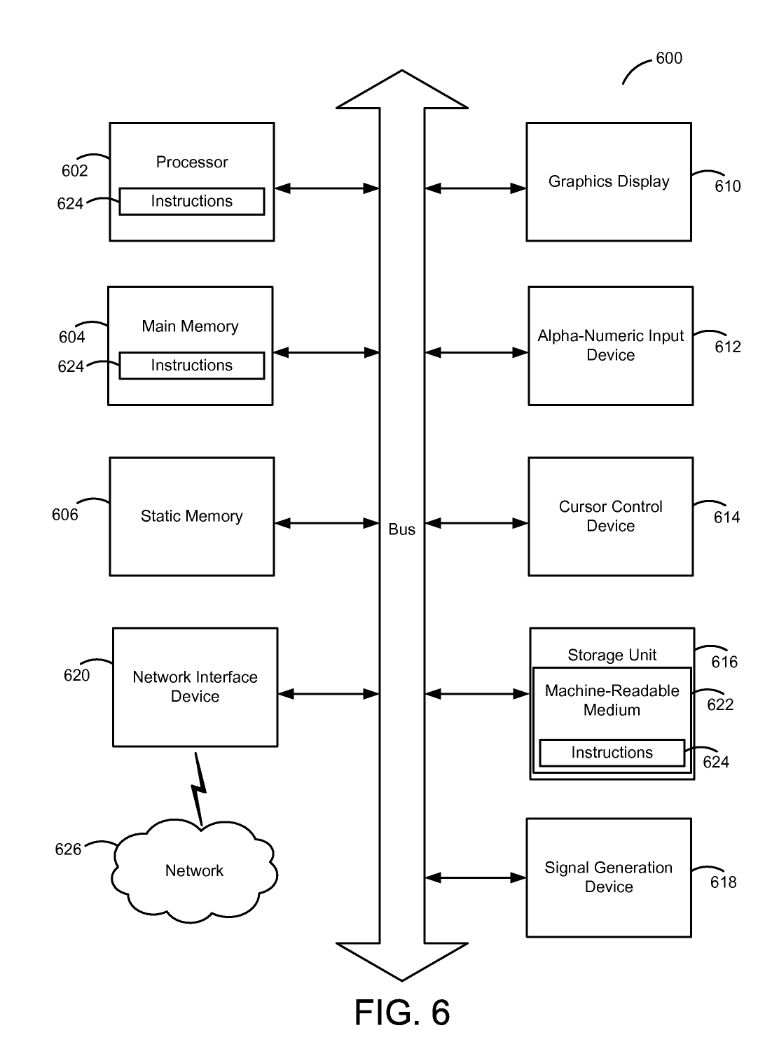

FIG. 6 is a block diagram illustrating components of an example machine able to read instructions from a machine-readable medium and execute them in a processor (or controller), as an example of a machine suitable for operating as the server 110, the target device 120, or the monitoring device 130. Specifically, FIG. 6 shows a diagrammatic representation of a machine in the example form of a computer system 600 within which instructions 624 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes a processor 602 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 604, and a static memory 606, which are configured to communicate with each other via a bus 608. The computer system 600 may further include graphics display unit 610 (e.g., a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a storage unit 616, a signal generation device 618 (e.g., a speaker), and a network interface device 820, which also are configured to communicate via the bus 608.

The storage unit 616 includes a machine-readable medium 622 on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 (e.g., software) may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store instructions (e.g., instructions 624). The term “machine-readable medium” shall also be taken to include any medium that is capable of storing instructions (e.g., instructions 624) for execution by the machine and that cause the machine to perform any one or more of the methodologies disclosed herein. The term “machine-readable medium” includes, but not be limited to, data repositories in the form of solid-state memories, optical media, and magnetic media.

The foregoing description of various embodiments has been presented for the purpose of illustration; it is not intended to be exhaustive or to limit the features to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein. Finally, the language used in the specification has been principally selected for readability and instructional purposes, and it may not have been selected to delineate or circumscribe the inventive subject matter.

What is claimed is:

1. A method for monitoring usage of a target mobile device, the method comprising:
receiving at the target mobile device one or more access restrictions from a server communicating with the target mobile device over a network, each access restriction specifying a condition defined by a first user for causing the target mobile device to take an action restricting use of the target mobile device by a second user;
monitoring usage of the target mobile device responsive to receiving the one or more access restrictions;
reporting the monitored usage to a monitoring device accessed by the first user; and
responsive to detecting satisfying of the condition, taking the action to restrict the use of the target mobile device by the second user.

2. The method of claim 1, wherein the condition includes a time limit for use of an application at the target mobile device, and wherein taking the action comprises terminating the application at the time limit.

3. The method of claim 1, further comprising:
receiving a command from the monitoring device to limit access to the target mobile device independent of the one or more access restrictions; and
taking another action to restrict the use of the target mobile device by the second user responsive to receiving the command.

4. The method of claim 1, wherein the condition includes identifying of an unpermitted application installed on the target mobile device, and wherein taking the action comprises blocking execution of the unpermitted application at the target mobile device.

5. The method of claim 1, wherein the condition includes installation by the second user of an unpermitted application, and wherein taking the action comprises uninstalling the unpermitted application from the target mobile device.

6. The method of claim 1, wherein the condition defines a total amount of time the target mobile device can be used, and wherein taking the action comprises disallowing use of the target mobile device.

7. The method of claim 1, wherein monitoring usage of the applications on the target mobile device comprises:
receiving an identifier of an application having an active window displayed on the target mobile device; and
monitoring an amount of time the active window of the application is displayed on the target mobile device.

8. The method of claim 1, further comprising reporting an installation of an application on the target mobile device after a predetermined time to the monitoring device to cause the monitoring device to display identification of the new application to the first user.

9. The method of claim 1, further comprising:
retrieving a list of applications installed on the target mobile device; and
reporting the list of applications to the server.

10. The method of claim 9, wherein retrieving the list of applications installed on the target mobile device comprises retrieving an internal name of each application from an operating system of the target mobile device.

11. The method of claim 1, further comprising:
receiving a request from the server for a status of the target mobile device, the request generated at the server in response to an input by the first user at the monitoring device;
determining the status of the target mobile device, and
sending the determined status to the server.

12. The method of claim 1, wherein reporting the monitored usage to the monitoring device comprises:
responsive to determining communication is unavailable between the target mobile device and the server, storing the monitored usage at the target mobile device for transmittal to the server when the communication between the target mobile device and the server becomes available.

13. A method for monitoring usage of a target mobile device, the method comprising:
storing at a server, one or more access restrictions received from a monitoring device, each access restriction specifying a condition defined at the monitoring device by a first user for causing the target mobile device to take an action restricting use of the target mobile device by a second user, the server communicating with the monitoring device and the target mobile device over a network;
sending the one or more access restrictions to the target mobile device causing the target mobile device to take the action to restrict use of the target mobile device by the second user responsive to detecting satisfying of the condition;
receiving usage statistics from the target mobile device, the usage statistics describing use of the target mobile device by the second user; and
sending the usage statistics to the monitoring device.

14. The method of claim 13, further comprising:
receiving usage statistics from a plurality of other target mobile devices communicating with the server over a network;
anonymizing the usage statistics received from the target mobile device and the usage statistics received from the plurality of other target mobile devices; and
generating an aggregated representation of the anonymized usage statistics.

15. The method of claim 13, further comprising:
receiving a command from the monitoring device to limit access to the target mobile device independent of the one or more access restrictions; and
sending the command to the target mobile device, the target mobile device configured to take another action to restrict the use of the target mobile device by the second user responsive to receiving the command.

16. A method for monitoring usage of a target mobile device at a monitoring device, the method comprising:
receiving one or more access restrictions at the monitoring device from a first user, each access restriction specifying a condition for causing the target mobile device to take an action restricting use of the target mobile device by a second user;
sending the access restrictions to a server communicating with the monitoring device over a network, the target mobile device configured to retrieve the access conditions from the server and take the action to restrict the use of the target mobile device by the second user responsive to detecting satisfying of the condition;
receiving from the target mobile device, usage statistics describing use of the target mobile device by the second user; and
displaying the usage statistics to the first user.

17. The method of claim 16, wherein displaying the usage statistics to the first user comprises:
displaying identifiers of one or more applications used on the target mobile device by the second user and an amount of time each of the one or more applications was used.

18. The method of claim 16, wherein displaying the usage statistics to the first user comprises:
displaying an identifier of an application installed on the target mobile device by the second user after a predetermined time.

19. The method of claim 16, further comprising:
receiving a command from the first user to limit access to the target mobile device independent of the one or more access restrictions; and
sending the command to the target mobile device, the target mobile device configured to take another action to restrict use of the target mobile device by the second user responsive to receiving the command.

20. The method of claim 16, further comprising:
receiving an input from the first user to request a status of the target mobile device;
responsive to receiving the input, sending to the server a request for a status of the target mobile device, the server configured to request the status from the target mobile device; and
responsive to receiving the status of the target mobile device from the server, displaying the status to the first user.

21. A non-transitory computer-readable storage medium storing computer program instructions, the computer program instructions when executed by a processor causing the processor to:
receive one or more access restrictions from a server, each access restriction specifying a condition defined by a first user for causing a target mobile device to take an action restricting use of the target mobile device by a second user;
monitor usage of the target mobile device responsive to receiving the one or more access restrictions;
report the monitored usage to a monitoring device accessed by the first user; and
responsive to detecting satisfying of the condition, take the action to restrict the use of the target mobile device by the second user.

22. A non-transitory computer-readable storage medium storing computer program instructions, the computer program instructions when executed by a processor causing the processor to:
store one or more access restrictions received from a monitoring device, each access restriction specifying a condition defined at the monitoring device by a first user for causing the target mobile device to take an action restricting use of the target mobile device by a second user;
send the one or more access restrictions to the target mobile device causing the target mobile device to take the action to restrict use of the target mobile device by the second user responsive to detecting satisfying of the condition;
receive usage statistics from the target mobile device, the usage statistics describing use of the target mobile device by the second user; and
send the usage statistics to the monitoring device.

23. A non-transitory computer-readable storage medium storing computer program instructions, the computer program instructions when executed by a processor causing the processor to:
receive one or more access restrictions from a first user, each access restriction specifying a condition for causing the target mobile device to take an action restricting use of a target mobile device by a second user;
sending the access restrictions to a server causing the target mobile device to retrieve the access conditions from the server and take the action to restrict the use of the target mobile device by the second user responsive to detecting satisfying of the condition;
receiving from the target mobile device, usage statistics describing use of the target mobile device by the second user; and
displaying the usage statistics to the first user.
